(19) United States
(12) Patent Application Publication
(10) Pub. No.: US 2006/0046947 A1
(43) Pub. Date: Mar. 2, 2006

(54) Supercritical fluid with nanoparticles

(75) Inventor: Ga-Lane Chen, Fremont, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/977,971

(22) Filed: Oct. 29, 2004

(30) Foreign Application Priority Data
Nov. 18, 2003 (CN) 200310112316.1

(51) Int. Cl. C11D 17/00

(52) U.S. Cl. 510/407

(57) ABSTRACT

A supercritical fluid includes a supercritical fluid matrix and a plurality of nanoparticles dispersed therein. The supercritical fluid matrix is selected from the group consisting of carbon dioxide, water, argon, nitrogen oxides, ethane, propane, and any suitable combination or mixture thereof. The nanoparticles are selected from the group consisting of carbon nanocapsules, carbon nanotubes and titanium dioxide nanoparticles. The supercritical fluid has improved cleaning ability, and can be widely used in various fields such as in the semiconductor industry, the surface chemical industry, in environment protection, and so on.

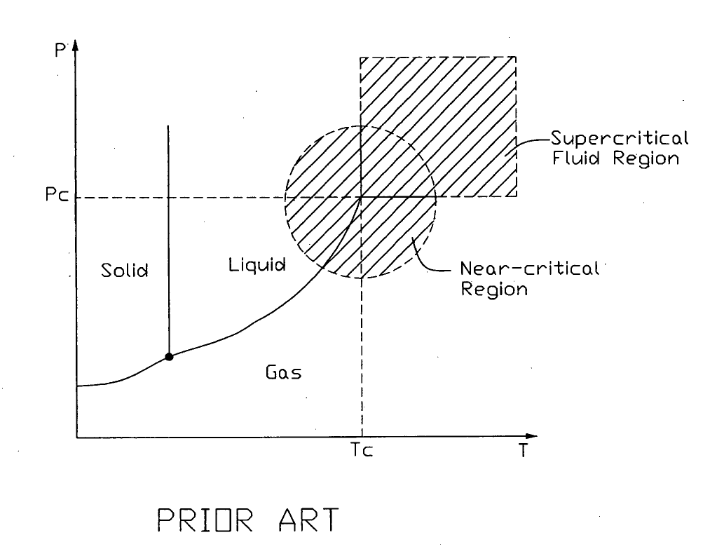

### BACKGROUND OF THE INVENTION

1. Field of the Invention

The present invention relates to supercritical fluids, and especially to a supercrtical fluid which can be used as a cleaner.

2. Description of Prior Art

Supercritical fluids (SCFs) are fluids that exist at a temperature and a pressure equal to or greater than the critical temperature and pressure of the particular substance. A supercritical state is a state which is characterized by the temperature and the pressure being equal to or greater than the critical temperature and pressure. At the supercritical state, the properties of a fluid in the gaseous phase of the substance are very similar to the properties of the fluid in the liquid phase of the substance, such that one cannot identify whether the fluid is in the gaseous phase or the liquid phase. Thus, under such conditions the fluid is called a supercritical fluid.

Carbon dioxide is a relatively harmless, nonflammable, low cost, and inert substance. With these advantages, carbon dioxide is one of the most widely used supercritical fluids. Carbon dioxide can be converted from the gaseous phase to the liquid phase at a low temperature and high pressure to form supercritical carbon dioxide. The supercritical carbon dioxide has both gaseous and liquid characteristics. That is, the supercritical carbon dioxide has not only the high diffusion coefficient and low viscosity of a gas, but also the density and good solution capability of a liquid. Thus, supercritical carbon dioxide has high solvency for dissolving organic contaminants, and is very suitable for cleaning small and light products such as semiconductor wafers and delicate communication products. In addition, supercritical carbon dioxide can substantially reduce the need for using water and other agents when cleaning. Thus, there is little or no pollution. However, supercritical carbon dioxide cannot readily dissolve and remove inorganic contaminants such as dust and various heavy metal particles.

Therefore it is desired to provide a supercritical fluid which overcomes the above-described shortcomings of the prior art.

### SUMMARY OF THE INVENTION

An object of the present invention is to provide a supercritical fluid which has improved cleaning ability.

In order to achieve the object set out above, a supercritical fluid of the present invention comprises a supercritical fluid matrix and a plurality of nanoparticles dispersed therein. The supercritical fluid matrix is preferably supercritical carbon dioxide. Further, the supercritical fluid matrix can comprise substances selected from the group consisting of carbon dioxide, water, argon, nitrogen oxides, ethane, propane, and any suitable combination or mixture thereof. The nanoparticles can be selected from the group consisting of carbon nanocapsules, carbon nanotubes, and titanium dioxide nanoparticles. The nanoparticles each have a large surface area and good absorption capability. Therefore, the properties of the supercritical fluid matrix are modified by the nanoparticles. As a result the supercritical fluid has improved cleaning ability, and can be widely used in various fields such as in the semiconductor industry, the surface chemical industry, in environment protection, and so on.

Other objects, advantages and novel features of the present invention will become more apparent from the following detailed description and claims, and from the accompanying drawing.

### BRIEF DESCRIPTION OF THE DRAWING

The drawing is a phase diagram of carbon dioxide.

### DETAILED DESCRIPTION OF PREFERRED EMBODIMENTS OF THE INVENTION

The drawing is a phase diagram of carbon dioxide, showing the relationship between temperature T and pressure P thereof. The square portion is a supercritical region of carbon dioxide. The critical point of the supercritical region is the end point of the plot separating the gaseous and liquid phases of carbon dioxide. The relative densities of the gaseous and liquid phases of carbon dioxide are identical at the critical point. When the temperature is over the critical temperature Tc, the properties of the supercritical fluid are similar to a gas at low pressure, and similar to a liquid at high pressure. Therefore, the supercritical fluid has properties shared between the gaseous and liquid phases, which properties can be easily adjusted by adjusting the pressure. In particular, the supercritical fluid has the properties of low viscosity, high flowability, a large mass transfer coefficient similar to that of a gas, and a relative density and a solubility greater than that of the gaseous phase and similar to that of the liquid phase. In addition, the dielectric constant, polarization rate and molecular characteristics of the supercritical fluid are greatly different from those of the gaseous or liquid phases.

A supercritical fluid in accordance with the present invention comprises a supercritical fluid matrix, and a plurality of nanoparticles dispersed in the supercritical fluid matrix as acting mediums. According to a first embodiment of the present invention, the supercritical fluid matrix is supercritical carbon dioxide, and the nanoparticles are carbon nanocapsules. A process for making the supercritical fluid includes the following steps: putting carbon nanocapsules into a compressed supercritical carbon dioxide; mixing the carbon nanocapsules uniformly to form a solid mixture or a solid-liquid mixture; and sealing the solid mixture or the solid-liquid mixture in an airtight container having a valve.

When using the supercritical fluid, the valve is opened at the critical temperature and the critical pressure or a pressure greater than the critical pressure. The critical temperature is 31 degrees Celsius, and the critical pressure is 1050 psig (pounds per square inch gauge). Carbon dioxide of the solid mixture or the solid-liquid mixture in the container transforms into supercritical carbon dioxide. The supercritical carbon dioxide with the carbon nanocapsules is sprayed at a high speed onto an object to be cleaned. In one aspect, the supercritical carbon dioxide has good solution and diffusion coefficients. That is, the supercritical carbon dioxide has good solvency, diffusivity, and penetration of organic contaminants, because carbon dioxide is a non-polar solvent. In another aspect, the carbon nanocapsules are multi-side global carbon clusters made of multilayer graphite. A diameter of each carbon nanocapsule is in the range from about several nanometers to several tens of nanaometers. Thus the carbon nanocapsules each have a large surface area and good absorption capability, and can absorb inorganic contaminants. The supercritical fluid is able to clean not only organic contaminants, but also inorganic contaminants. This gives the supercritical fluid improved cleaning ability.

A second embodiment of the supercritical fluid of the present invention is the same as the first embodiment, except that the nanoparticles are carbon nanotubes instead of carbon nanocapsules. A process for making the supercritical fluid of the second embodiment is the same as that for the first embodiment. Carbon nanotubes are uniaxial single-walled or multi-walled nano-sized hollow tubes formed by rolled graphite sheets. Thus, the carbon nanotubes each have a large surface area and good absorption capability. The supercritical fluid is able to clean not only organic contaminants, but also inorganic contaminants. This gives the supercritical fluid improved cleaning ability.

A third embodiment of the supercritical fluid of the present invention is the same as the first embodiment, except that the nanoparticles are titanium dioxide nanoparticles. A process for making the supercritical fluid of the third embodiment is the same as that for the first embodiment. A diameter of each titanium dioxide nanoparticle is in the range from about several nanometers to several tens of nanometers. The titanium dioxide nanoparticles provide the added advantage of a photocatalyst effect. The supercritical fluid is not only able to clean organic and inorganic contaminants. The supercritical fluid can also kill bacteria when it is irradiated by light. This gives the supercritical fluid improved cleaning ability.

According to the above-described characteristics of the supercritical fluid, it is to be understood that the supercritical fluid matrix can comprise carbon dioxide (as per the above-described embodiments), water, argon, nitrogen oxides, ethane, propane, or any suitable combination or mixture thereof. Different supercritical matrixes have different critical temperatures and pressures. As stated, carbon dioxide's critical temperture is 31 degrees Celsius and its critical pressure is 1050 psig. The solvencies of ethane and propane are both better than that of carbon dioxide. However, ethane and propane can very easily explode at room temperature. When configuring the supercritical fluid matrix and the supercritical fluid, it is very important to do so having regard to their particular physical and chemical properties.

Another advantage of using the supercritical fluid of the present invention as a cleaner is that it can significantly lessen the need for using water and a subsequent drying agent. There is no need to deal with residual waste water containing contaminants. In the three described embodiments, during the drying process, the carbon dioxide supercritical fluid matrix of the supercritical fluid of the present invention transforms into the gaseous phase due to the decrease in pressure. This readily provides drying of the object being cleaned. Thus, there is no need to use desiccants such as alcohol to facilitate drying.

The supercritical fluid of the present invention can deeply clean into the tiny apertures of integrated circuits. The supercritical fluid is suitable for cleaning semiconductor wafers, and other electronics-related products such as color filters. In addition, the supercritical fluid can also be used to clean painted and glass surfaces of consumer products such as motor cars. Oil, dust, and various heavy metal contaminants attached on these surfaces can be conveniently removed. Therefore the supercritical fluid of the present invention can be widely used as a cleaner in various fields such as in the semiconductor industry, the surface chemical industry, in environment protection, and so on.

While the present invention has been described with reference to particular embodiments, the description is illustrative of the invention and is not to be construed as limiting the invention. Various modifications to the present invention can be made to the described embodiments by those skilled in the art without departing from the true spirit and scope of the invention as defined by the appended claims.

What is claimed is:

1. A supercritical fluid comprising:
a supercritical fluid matrix and a plurality of nanoparticles dispersed therein.

2. The supercritical fluid as claimed in claim 1, wherein the supercritical fluid matrix is supercritical carbon dioxide.

3. The supercritical fluid as claimed in claim 1, wherein the supercritical fluid matrix comprises substances selected from the group consisting of carbon dioxide, water, argon, nitrogen oxides, ethane, propane, and any suitable combination or mixture thereof.

4. The supercritical fluid as claimed in claim 1, wherein the nanoparticles are carbon nanocapsules.

5. The supercritical fluid as claimed in claim 1, wherein the nanoparticles are carbon nanotubes.

6. The supercritical fluid as claimed in claim 1, wherein the nanoparticles are titanium dioxide nanoparticles.

7. A supercritical fluid comprising a fluid matrix and a plurality of acting mediums uniformly dispersed in said fluid matrix for absorption of inorganic particles, and said supercritical fluid being workable in a preset pressure and temperature higher than a critical pressure and temperature of said fluid matrix.

8. The supercritical fluid as claimed in claim 7, wherein said fluid matrix is supercritical carbon dioxide.

9. The supercritical fluid as claimed in claim 7, wherein said plurality of acting mediums is a selective one in the group consisting of carbon nanocapsules, carbon nanotubes and titanium dioxide nanoparticles.

10. A method of providing supercritical fluid, comprising:
providing a compressed fluid matrix;
mixing a plurality of acting mediums having an absorption ability of inorganic particles into said fluid matrix; and
reserving mixture of said fluid matrix and said plurality of acting mediums in a circumstance of a preset pressure and temperature higher than a critical pressure and temperature of said fluid matrix.

11. The method as claimed in claim 10, wherein said fluid matrix is supercritical carbon dioxide.

12. The method as claimed in claim 10, wherein said plurality of acting mediums is a selective one in the group consisting of carbon nanocapsules, carbon nanotubes and titanium dioxide nanoparticles.
